(19) United States
(12) Patent Application Publication
(10) Pub. No.: US 2026/0104273 A1
(43) Pub. Date: Apr. 16, 2026

(54) ELECTRODE FOR CAPACITIVE GRATING DISPLACEMENT SENSOR

(71) Applicant: Guilin Gemred Sensor Technology Co., Ltd., Guilin (CN)

(72) Inventors: Bingheng LI, Guilin (CN); Guangjin LI, Guilin (CN); Guanglu YANG, Guilin (CN); Hui LU, Guilin (CN)

(21) Appl. No.: 19/354,802

(22) Filed: Oct. 9, 2025

(30) Foreign Application Priority Data
Oct. 10, 2024 (CN) 202422443666.6

(51) Int. Cl. G01D 5/241

(52) U.S. Cl. CPC G01D 5/2412

(57) ABSTRACT

An electrode for a capacitive grating displacement sensor. The electrode includes a movable grating plate and a stationary grating plate. The movable grating plate is slidably mounted on the stationary grating plate. The movable grating plate includes a transmitting electrode. The transmitting electrode includes a plurality of mutually inverted trapezoidal structures. The plurality of trapezoidal structures of the transmitting electrode are disposed at equal intervals along a sliding direction of the movable grating plate. The structure is configured to reduce, or even substantially eliminate, the abrupt non-linear errors that arise when the edges of the insulating grooves between conventional transmitting electrodes align with the edges of the electrodes on the stationary grating. This improvement enables an enhancement in the overall measurement accuracy of a measurement device. Additionally, the proposed electrode improves the signal-to-noise ratio of the electrode coupling, resulting in more stable measurement data.

### CROSS-REFERENCE TO RELATED APPLICATIONS

Pursuant to 35 U.S.C.§ 119 and the Paris Convention Treaty, this application claims foreign priority to Chinese Patent Application No. 202422443666.6 filed Oct. 10, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of displacement sensors, and more particularly to an electrode for a capacitive grating displacement sensor.

Capacitive grating displacement sensors, also known as capacitive linear encoders or caliper-type sensors, are digital sensors that operate on a variable area principle. They achieve long-range displacement measurement by employing a series of electrode patterns arranged periodically along the axis of displacement. Such sensors have been utilized in digital measuring tools, such as digital calipers, for several decades. They remain widely adopted due to their unique advantages, including compact size and low power consumption. A typical configuration of a conventional capacitive linear displacement sensor includes a stationary grating plate and a movable grating plate configured to slide linearly along the stationary plate. The stationary grating plate comprises a series of electrodes arranged at regular intervals along the direction of movement. The movable grating plate includes a set of transmitting electrodes and receiving electrodes. The transmitting electrodes are composed of a series of rectangular electrodes equidistantly arranged along the movement direction, with individual electrodes being isolated from one another by insulating grooves of a certain width.

A significant limitation impeding further enhancement of measurement accuracy in these conventional sensors stems from the finite width of the insulating grooves separating the series of rectangular transmitting electrodes on the movable grating plate. Due to constraints inherent in standard printed circuit board (PCB) mass-production manufacturing processes, the width of these insulating grooves is typically at least 0.076 mm. When these transmitting electrodes are positioned in parallel coupling with the corresponding electrodes on the stationary grating plate, the presence of these non-negligible grooves introduces substantial non-linear effects that adversely affect measurement accuracy. Attempts to mitigate this issue by merely reducing the inter-electrode gap to less than 0.076 mm are problematic. Such an approach not only increases manufacturing difficulty and cost but, more fundamentally, fails to eliminate the underlying source of non-linearity.

### SUMMARY

One objective of the disclosure is to provide an electrode for a capacitive grating displacement sensor that overcomes the adverse effects on measurement accuracy caused by the gaps between the series of transmitting electrodes. The structure is configured to reduce, or even substantially eliminate, the abrupt non-linear errors that arise when the edges of the insulating grooves between conventional transmitting electrodes align with the edges of the electrodes on the stationary grating. This improvement enables an enhancement in the overall measurement accuracy of a measurement device. Additionally, the proposed electrode improves the signal-to-noise ratio of the electrode coupling, resulting in more stable measurement data.

The disclosure provides an electrode for a capacitive grating displacement sensor, the electrode comprising: a movable grating plate and a stationary grating plate. The movable grating plate is slidably mounted on the stationary grating plate; the movable grating plate comprises a transmitting electrode; the transmitting electrode comprises a plurality of mutually inverted trapezoidal structures; and the plurality of trapezoidal structures of the transmitting electrode are disposed at equal intervals along a sliding direction of the movable grating plate.

Configuring the transmitting electrode as a series of mutually inverted trapezoidal structures helps to reduce, or even substantially eliminate, the adverse impact of abrupt non-linear errors generated when the gaps between conventional transmitting electrodes align with the edges of the stationary grating electrodes. This configuration thereby improves the overall measurement accuracy of a measurement device. Furthermore, the electrode gap width can be designed according to the capabilities of standard PCB fabrication processes, which is conducive to manufacturability.

In a class of this embodiment, the stationary grating plate comprises a plurality of coupling electrodes, and the plurality of coupling electrodes are disposed at equal intervals along the sliding direction of the movable grating plate.

The coupling electrodes are configured to correspond with the transmitting electrodes during the sliding movement of the movable grating plate along the stationary grating plate. A linear variation in the relative area between these electrodes induces a corresponding change in capacitance, which is subsequently measured and converted into a displacement value.

In a class of this embodiment, a distance between two adjacent ones of the plurality of coupling electrodes defines a pitch length; a coupling width of the coupling electrode with the transmitting electrode is less than or equal to one-half of the pitch length; and a center-to-center distance between two of the trapezoidal structures of the transmitting electrode is one-eighth of the pitch length.

The design facilitates compatibility with the signal processing requirements of existing sensor chips, thereby reducing the development cost for sensor chips.

In a class of this embodiment, in the plurality of mutually inverted trapezoidal structures of the transmitting electrode, a length of a long base of a trapezoid is greater than one-eighth of the pitch length.

The technical solution helps to increase the amount of displacement variation per unit length, thereby improving the signal-to-noise ratio per unit coupling electrode and resulting in more stable measurement data.

In a class of this embodiment, in the plurality of mutually inverted trapezoidal structures of the transmitting electrode, a line connecting an edge of a short base of one trapezoidal structure to an edge of a long base of an adjacent inverted trapezoidal structure is parallel to an edge of the coupling electrode.

The technical solution ensures the variation in electrical parameters between the coupling electrodes and the transmitting electrodes during displacement conforms to the linearity requirements of a variable-area capacitive sensor. This configuration thereby achieves the objective of eliminating the abrupt non-linear error generated when the gaps between conventional transmitting electrodes align with the edges of the stationary grating electrodes.

In a class of this embodiment, the movable grating plate further comprises a receiving electrode.

The receiving electrode is configured to receive the data corresponding to the linear capacitive change generated by the transmitting electrode and to transmit this data to the sensor chip for processing.

### BRIEF DESCRIPTION OF THE DRAWINGS

FIG. 1 is a schematic diagram of an electrode for a capacitive grating displacement sensor according to one embodiment of the disclosure;

FIG. 2 is an enlarged schematic view of part B in FIG. 1;

FIG. 3 is a schematic diagram of an electrode for an absolute capacitive grating displacement sensor according to another embodiment of the disclosure.

In the drawings, the reference numerals are used: 1. Movable grating plate; 2. Stationary grating plate; 11. Transmitting electrode; 12 Receiving electrode; 21. Coupling electrode.

### DETAILED DESCRIPTION

To further illustrate the disclosure, embodiments detailing an electrode for a capacitive grating displacement sensor are described below. It should be noted that the following embodiments are intended to describe and not to limit the disclosure.

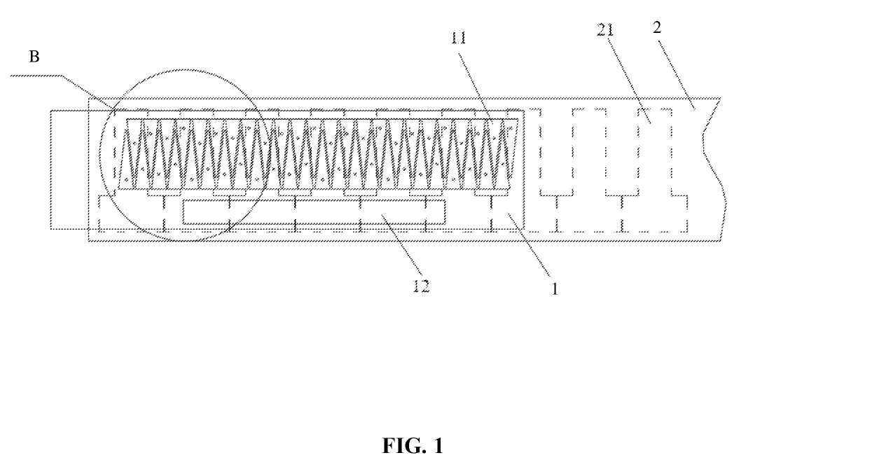

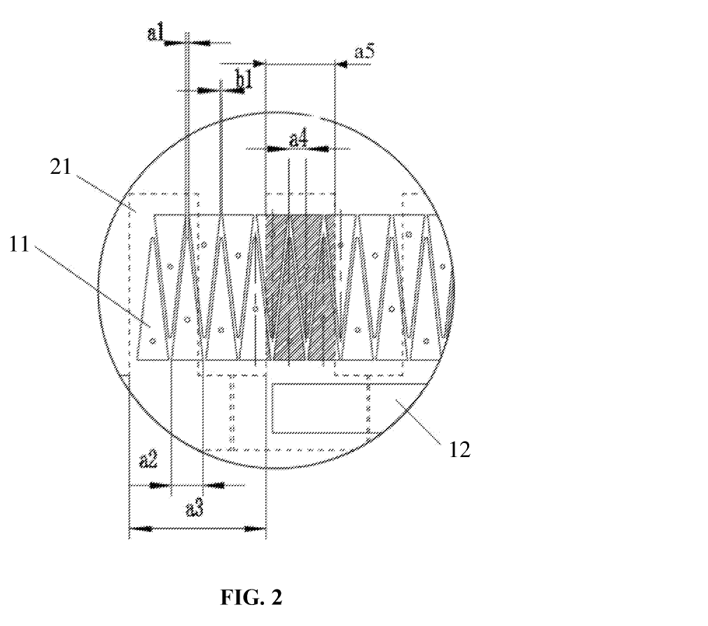

As shown in FIGS. 1-2, the disclosure provides an electrode for a capacitive grating displacement sensor, and the electrode comprises a movable grating plate 1 and a stationary grating plate 2. The movable grating plate 1 is slidably mounted on the stationary grating plate 2; the movable grating plate 1 comprises a transmitting electrode 11; the transmitting electrode 11 comprises a plurality of mutually inverted trapezoidal structures; and the plurality of trapezoidal structures of the transmitting electrode 11 are disposed at equal intervals along a sliding direction of the movable grating plate 1.

In the technical solution of the present disclosure, the capacitive grating displacement sensor is configured to measure displacement in cooperation with a sensor chip. When the movable grating plate 1 slides along the stationary grating plate 2, the relative area between the transmitting electrode 11 and the coupling electrodes 21 on the stationary grating plate 2 undergoes continuous variation. This variation in area induces a corresponding change in capacitance between the electrodes. The sensor chip processes this capacitive change and converts it into a displacement value. The data transmission and the processing of data by the sensor chip in this process belong to the prior art.

In conventional designs, the presence of isolation gaps between the transmitting electrodes prevents the parameter of the coupling capacitance from varying linearly during the movement of the movable grating plate, particularly when the gaps traverse the coupling region. Although fringing effects may provide a degree of compensation, a non-linear variation in the measurement signal persists. This non-linearity consequently limits the overall accuracy of the capacitive grating sensor. In the technical solution of the disclosure, because the transmitting electrode 11 comprises a plurality of mutually inverted trapezoidal structures, the variation in the relative area between the transmitting electrode 11 and the coupling electrodes 21 on the stationary grating plate 2, as the movable grating plate 1 slides, is more gradual compared to the conventional art. This results in a significant reduction of the abrupt non-linear error, thereby enhancing the overall measurement accuracy of a measurement device.

The beneficial effects of the technical solution of the disclosure are as follows: Configuring the transmitting electrode as a series of mutually inverted trapezoidal structures helps to reduce, or even substantially eliminate, the adverse impact of abrupt non-linear errors generated when the gaps between conventional transmitting electrodes align with the edges of the stationary grating electrodes. This configuration thereby improves the overall measurement accuracy of a measurement device. Furthermore, the electrode gap width can be designed according to the capabilities of standard PCB fabrication processes, which is conducive to manufacturability.

As shown in FIGS. 1-2, the stationary grating plate 2 comprises a plurality of coupling electrodes 21, and the plurality of coupling electrodes 21 are disposed at equal intervals along the sliding direction of the movable grating plate 1.

The coupling electrodes are configured to correspond with the transmitting electrodes during the sliding movement of the movable grating plate along the stationary grating plate. A linear variation in the relative area between these electrodes induces a corresponding change in capacitance, which is subsequently measured and converted into a displacement value.

As shown in FIG. 2, a distance between two adjacent coupling electrodes 21 defines a pitch length a3. A coupling width a5 of the coupling electrode 21 with the transmitting electrode 11 is less than or equal to one-half of the pitch length a3. A center-to-center distance a4 between two of the trapezoidal structures of the transmitting electrode 11 is one-eighth of the pitch length a3.

The beneficial effect of employing the technical solution is that the design facilitates compatibility with the signal processing requirements of existing sensor chips, thereby reducing the development cost for sensor chips.

Preferably, as shown in FIG. 2, in the plurality of mutually inverted trapezoidal structures of the transmitting electrode 11, a length a2 of the long base of a trapezoid is greater than one-eighth of the pitch length a3.

The technical solution helps to increase the amount of displacement variation per unit length, thereby improving the signal-to-noise ratio per unit coupling electrode and resulting in more stable measurement data.

Preferably, as shown in FIG. 2, in the plurality of mutually inverted trapezoidal structures of the transmitting electrode 11, a line connecting an edge of a short base of one trapezoidal structure to an edge of a long base of an adjacent inverted trapezoidal structure is parallel to an edge of the coupling electrode 21.

The technical solution ensures the variation in electrical parameters between the coupling electrodes and the transmitting electrodes during displacement conforms to the linearity requirements of a variable-area capacitive sensor. This configuration thereby achieves the objective of eliminating the abrupt non-linear error generated when the gaps between conventional transmitting electrodes align with the edges of the stationary grating electrodes.

Preferably, as shown in FIG. 1 and FIG. 2, the movable grating plate 1 further comprises a receiving electrode 12.

In this way, the receiving electrode is configured to receive the data corresponding to the linear capacitive change generated by the transmitting electrode and to transmit this data to the sensor chip for processing.

It is to be noted that, as shown in FIG. 2, in a preferred embodiment of the disclosure, a length a1 of the short base of a trapezoidal structure in the transmitting electrode 11 is equal to a gap width b1 between two adjacent trapezoidal structures within the transmitting electrode 11. In the technical solution of the disclosure, a smaller difference between the short base length a1 and the gap width b1 results in a more effective reduction of the non-linear error caused by the gaps. Furthermore, configuring the short base of the trapezoid as an arc, or setting a1 to zero (effectively forming an isosceles triangle), also contributes to mitigating the non-linear error induced by the electrode gaps.

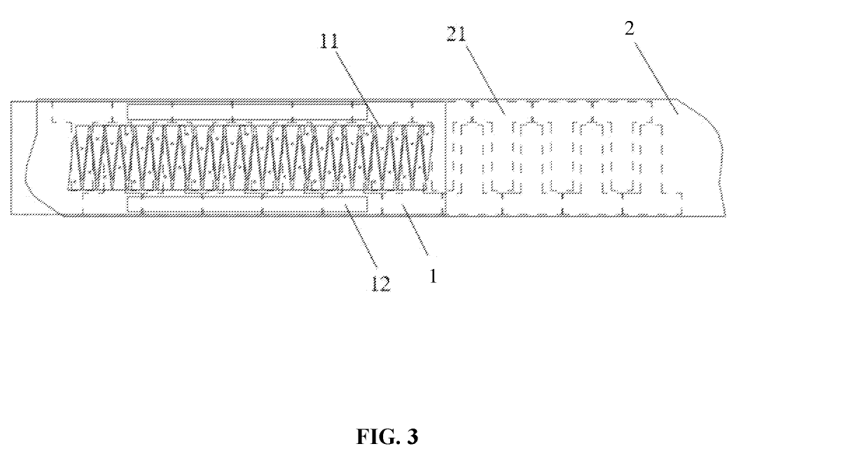

Preferably, as shown in FIG. 3, the structure of the transmitting electrode 11 described above is applicable not only to conventional incremental capacitive grating sensors but also to differential absolute-type capacitive grating sensors, and the design method and principles remain consistent with those applied to incremental capacitive grating sensors.

In the description of the present disclosure, it is to be understood that terms such as “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” and the like, which indicate orientations or positional relationships, are based on the orientations or positional relationships as shown in the accompanying drawings. These terms are used merely for the purpose of facilitating the description of the present disclosure and simplifying the description, and do not indicate or imply that the referred apparatus or elements must have a specific orientation or be constructed and operated in a specific orientation. Therefore, they are not to be construed as limiting the present disclosure.

Furthermore, the terms “first” and “second” are used for descriptive purposes only and are not to be construed as indicating or implying relative importance or implicitly specifying the quantity of the indicated technical features. Thus, features defined by “first” or “second” may explicitly or implicitly include one or more of such features. In the description of the present disclosure, the term “a plurality of” means at least two, such as two, three, etc., unless explicitly defined otherwise.

In the present disclosure, unless expressly specified or limited otherwise, the terms “mounted,” “connected,” “coupled,” “fixed,” and the like shall be construed broadly. For example, a “connection” may be a fixed connection, a detachable connection, or an integral connection; it may be a mechanical connection, an electrical connection, or may imply direct contact or communication through an intermediary medium. The specific meanings of these terms in the context of the present disclosure can be understood by those skilled in the art based on the specific circumstances.

In the present disclosure, unless expressly specified or limited otherwise, a first feature being “on” or “under” a second feature may mean that the first and second features are in direct contact, or that they are in indirect contact through an intermediary medium. Moreover, a first feature being “above,” “over,” or “on” a second feature may indicate that the first feature is directly above the second feature, obliquely above it, or merely that the horizontal level of the first feature is higher than that of the second feature. A first feature being “beneath,” “under,” or “below” a second feature may indicate that the first feature is directly below the second feature, obliquely below it, or merely that the horizontal level of the first feature is lower than that of the second feature.

In the description of this specification, references to “one embodiment,” “some embodiments,” “an example,” “a specific example,” or “some examples,” etc., mean that specific features, structures, materials, or characteristics described in connection with the embodiment or example are included in at least one embodiment or example of the present disclosure. In this specification, schematic representations using these terms do not necessarily refer to the same embodiment or example. Furthermore, the described specific features, structures, materials, or characteristics may be combined in any suitable manner in one or more embodiments or examples. Additionally, without contradiction, those skilled in the art can combine and integrate the different embodiments or examples and the features of the different embodiments or examples described in this specification.

It will be obvious to those skilled in the art that changes and modifications may be made, and therefore, the aim in the appended claims is to cover all such changes and modifications.

What is claimed is:

1. An electrode for a capacitive grating displacement sensor, the electrode comprising a movable grating plate and a stationary grating plate;
wherein:
the movable grating plate is slidably mounted on the stationary grating plate;
the movable grating plate comprises a transmitting electrode; the transmitting electrode comprises a plurality of mutually inverted trapezoidal structures; and
the plurality of trapezoidal structures of the transmitting electrode are disposed at equal intervals along a sliding direction of the movable grating plate.

2. The electrode of claim 1, wherein the stationary grating plate comprises a plurality of coupling electrodes, and the plurality of coupling electrodes are disposed at equal intervals along the sliding direction of the movable grating plate.

3. The electrode of claim 2, wherein
a distance between two adjacent ones of the plurality of coupling electrodes defines a pitch length;
a coupling width of the coupling electrode with the transmitting electrode is less than or equal to one-half of the pitch length; and
a center-to-center distance between two of the trapezoidal structures of the transmitting electrode is one-eighth of the pitch length.

4. The electrode of claim 3, wherein in the plurality of mutually inverted trapezoidal structures of the transmitting electrode, a length of a long base of a trapezoid is greater than one-eighth of the pitch length.

5. The electrode of claim 2, wherein in the plurality of mutually inverted trapezoidal structures of the transmitting electrode, a line connecting an edge of a short base of one trapezoidal structure to an edge of a long base of an adjacent inverted trapezoidal structure is parallel to an edge of the coupling electrode.

6. The electrode of claim 1, wherein the movable grating plate further comprises a receiving electrode.
